(19) United States
(12) Patent Application Publication
(10) Pub. No.: US 2010/0048755 A1
(43) Pub. Date: Feb. 25, 2010

(54) POROUS POLYMERIC MATERIAL WITH CROSS-LINKABLE WETTING AGENT

(76) Inventors: Edwin Pei Yong Chow, Singapore (SG); Jackie Y. Ying, Singapore (SG)

Correspondence Address: KLARQUIST SPARKMAN, LLP, 121 SW SALMON STREET, SUITE 1600, PORTLAND, OR, 97204, US

(21) Appl. No.: 12/515,264

(22) PCT Filed: Nov. 17, 2007
(86) PCT No.: PCT/SG2007/000398

§ 371 Date: May 15, 2009

Related U.S. Application Data
(60) Provisional application No. 60/859,517, filed on Nov. 17, 2006.

(51) Int. Cl. C08G 63/00; C08J 9/00; C08G 73/06

(52) U.S. Cl. 521/184; 521/50; 521/182; 521/189

(57) ABSTRACT

A porous material is provided which comprises a transparent polymer matrix defining interconnected pores and a wetting agent. At least a portion of the wetting agent is cross-linked with the polymer matrix. A process for forming a porous polymeric material is also provided. A bicontinuous microemulsion comprising water, a wetting agent, a monomer, and a surfactant copolymerizable with the monomer is polymerized, to form a polymer defining interconnected pores. The wetting agent comprises a cross-linkable wetting agent such that after polymerization, at least a portion of the cross-linkable wetting agent is cross-linked with the polymer. The wetting agent may comprise acrylated hyaluronic acid (AHA) such as methacrylated hyaluronic acid (MeHA). The wetting agent may also comprise a hyaluronic acid (HA). The wetting agent may include an unbonded portion that this releasable from the material. A contact lens may be made from the porous material.

### CROSS-REFERENCE TO RELATED APPLICATION

This application claims the benefit of U.S. provisional application No. 60/859,517, filed Nov. 17, 2006, the entire contents of which are incorporated herein by reference.

### FIELD OF THE INVENTION

The present invention relates to porous, polymeric materials with a wetting agent, and methods for making such materials.

### BACKGROUND OF THE INVENTION

Dry eye is a common condition that many people suffer, particularly when wearing contact lenses. A known technique to address dry eye condition is to incorporate a welting agent into the contact lens. When the contact lenses are worn by a user, the welting agent is released, thus welting the surface of the contact lens and reducing discomfort of the user. However, the useful lifetime of such contact lenses is limited due to the limited amount of wetting agent that can be incorporated into and released from a contact lens. Further, some welting agents tend to degrade in an aqueous environment, thus further limiting their application. It is thus desirable to provide porous materials with a wetting agent that has improved performance or can maintain stable performance over a relatively long period of time.

### SUMMARY OF THE INVENTION

Accordingly, in accordance with an aspect of the present invention, there is provided a method of forming a porous polymeric material. A bicontinuous microemulsion comprising water, a welting agent, a monomer, and a surfactant copolymerizable with the monomer is polymerized to form a polymer defining interconnected pores. The welting agent comprises a cross-linkable wetting agent such that after polymerization, at least a portion of the cross-linkable welting agent is cross-linked with the polymer. The welting agent may comprise a hyaluronic acid. The cross-linkable wetting agent may be an acrylated hyaluronic acid, such as a methacrylated hyaluronic acid. After polymerization, an unbonded portion of the wetting agent may be dispersed in the polymer and the pores, and the unbonded portion of the wetting agent may be releasable from the material. The wetting agent may comprise polyvinylpyrrolidone or dextran. The monomer may be methyl methacrylate or 2-hydroxyethyl methacrylate. The surfactant may be a zwitterionic surfactant, such as 3-((11 -acryloyloxyundecyl)-imidazolyl)propyl sulfonate, The microemulsion may comprise from about 0.1 to about 0.5 wt %, such as from about 0.25 to about 0.35 wt %, of the wetting agent. The microemulsion may comprise from about 15 to about 50 wt % of the water, from about 5 to about 40 wt % of the monomer, and from about 10 to about 60 wt % of the surfactant.

In accordance with another aspect of the present invention, there is provided a porous polymeric material formed according to a method described herein.

In accordance with further aspect of the present invention, there is provided a porous material comprising a transparent polymer matrix defining interconnected pores; and a wetting agent, at least a portion of the wetting agent cross-linked with the polymer matrix. The wetting agent may comprise methacylated hyaluronic acid (MeHA), and at least a portion of the MeHA may be cross-linked with the polymer matrix. The wetting agent may comprise an acrylated hyalumnic acid (AHA), and at least a portion of the AHA may be cross-linked with the polymer matrix. The wetting agent may comprise an unbonded portion dispersed in one or both of the polymer matrix and the pores, and the unbonded portion of the wetting agent may be releasable from the material. The wetting agent may comprise a hyaluronic acid, polyvinylpyrrolidone or dextran. The polymer matrix may comprise polymerized methyl methacrylate or 2-hydroxyethyl methacrylate. The material may comprise from about 0.1 to about 0.5 wt %, such as from about 0.25 to about 0.35 wt %, of the wetting agent. The pores may have a pore diameter of about 60 to about 120 nm.

In accordance with another aspect of the present Invention, there Is provided a contact lens comprising a porous polymeric material described herein.

Other aspects and features of the present invention will become apparent to those of ordinary skill in the art upon review of the following description of specific embodiments of the invention in conjunction with the accompanying figures.

### BRIEF DESCRIPTION OF THE DRAWINGS

In the figures, which illustrate, by way of example only, embodiments of the present invention,

FIG. 1 is a schematic diagram of a contact lens, exemplary of an embodiment of the present invention;

FIG. 2 is a chemical formula of a hyaluronic acid (HA);

FIG. 3 is a chemical formula of a methacrylated HA (MeHA);

FIGS. 4 to 6 are scanning electron microscopic (SEM) images of contact lens materials;

FIG. 7 shows a reaction route for preparing MeHA;

FIGS. 8 to 11 are schematic diagrams illustrating a process for forming a contact lens material from a microemulsion with a mould;

FIGS. 12 to 14 are chemical formulae of various compounds used for forming a surfactant;

FIG. 15 shows a ¹H-NMR spectra of a MeHA compound;

FIG. 16 is a bar diagram showing the measured transparency of different sample compounds;

FIG. 17 is a line diagram showing the release profile of different sample compounds; and

FIG. 18 is a bar diagram showing the measured modulus of different sample compounds.

### DETAILED DESCRIPTION

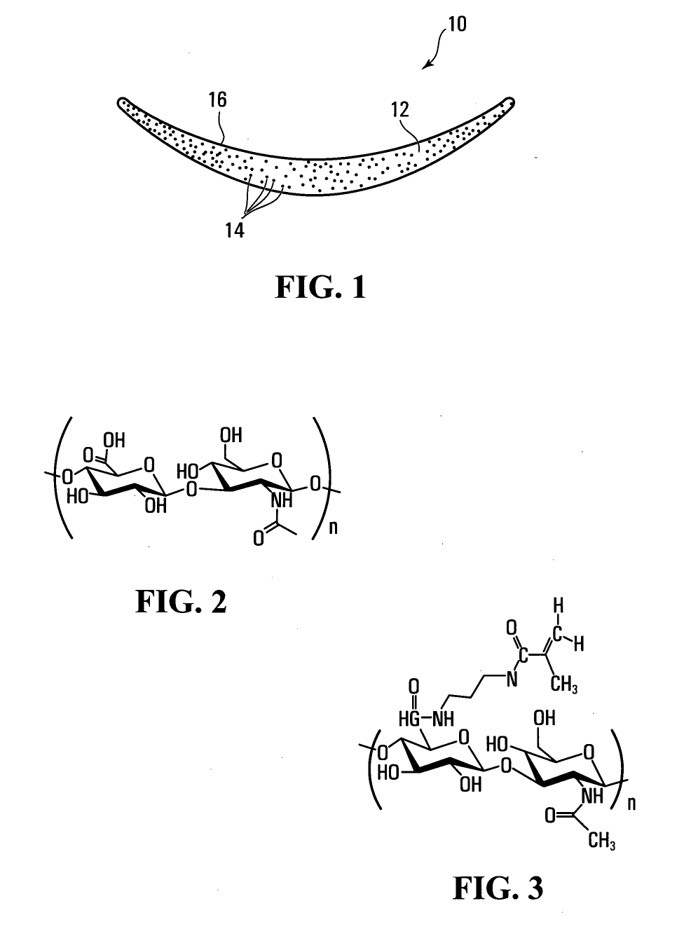

As schematically shown in FIG. 1, an exemplary embodiment of the present invention relates to a contact lens 10 made of a transparent and porous polymer 12. As used herein, the term “transparent” broadly describes the degree of transparency that is acceptable for a contact lens or like devices, for example the degree of transmission of visible light through the polymer equivalent to that of other materials employed in the manufacture of contact lenses or other ophthalmic devices.

Polymer 12 may include one or more polymerized monomer(s), such as ethylenically unsaturated monomers including methyl methacrylate (MMA), 2-hydroxylethyl methacrylate (HEMA), 2-hydroxylethyl acrylate, monocarboxylic acids such as acrylic acid (AA) and methacrylic acid (MA), glycidyl methacrylate (GMA), silicone-type monomers, or the like.

A wetting agent (WA) 14 is incorporated into contact lens 10. At least a portion of WA 14 is cross-linked with polymer 12, which is referred to herein as the “cross-linked portion.” As used herein, a wetting agent molecule is “cross-linked” with polymer 12 when the wetting agent molecule is joined to two or more adjacent chains of polymer 12 by covalent bonds. Some of WA 14 may be dispersed in one or both of polymer 12 and the pores defined by polymer 12 but are not cross-linked with polymer 12, and such WA 14 is referred to herein as the “unbonded portion.” If included, the unbonded portion of WA 14 may be releasable from contact lens 10 into the eye when contact lens 10 is placed on the eye and a surface 16 of contact lens 10 is in contact with the eye. WA 14 may include one or more wetting agents. In particular, the cross-linked portion of WA 14 includes one or more cross-linkable wetting agents (CLWA). The unbonded portion of WA 14 may include one or more CLWA or one or more non-cross-linkable wetting agents (n-CLWA), or a mixture of CLWA and n-CLWA. The cross-linked and unbonded portions of WA 14 may be formed from the same wetting agent(s) or from different wetting agent(s).

WA 14 may include any wetting agent, subject to constraints in any given particular application. For example, for contact lens applications, the wetting agent should be compatible with human eye. In a contact lens application, suitable wetting agents may include hyaluronic acid (HA), acrylated HA (AHA), methacrylated hyaluronic acid (MeHA), polyvinylpyrrolidone (PVP), dextran, or other wetting agents that are suitable for ophthalmic applications. The term “or” when used herein in a list of items indicates that each of the listed items is itself a possible alternative and that any combination of any two or more of the listed items is also a possible alternative, excluding any combination that is not suitable, as would be understood by a skilled person in the art, such as when two items in the combination are mutually exclusive. In some applications, wetting agents such as carboxymethylcellulose (CMC), hydroxypropyl methylcellulose (HPMC), glycerine, chitosan, polyvinylalcohol, or the like may be suitable.

HA is also called hyaluronate or hyaluronan. A HA is a glycosaminoglycan, also called mucopolysaccharide, which is a polymer of disaccharides, composed of D-glucuronic acid and D-N-acetylglucosamine, linked together via alternating β-1,4 and β-1,3 glycosidic bonds. An exemplary HA is a sodium hyaluronate.

For example, a suitable HA may be of the chemical formula shown in FIG. 2. A suitable MeHA may have the formula shown in FIG. 3. In both FIGS. 2 and 3, the number “n” may be selected so that the molecule has a molecular weight from about 10 to about 100,000 Dalton. In some other embodiments, the molecular weight of a suitable WA may be between about 100 and about 10,000,000 Dalton. In different embodiments, the molecular weight may vary and may be outside the above ranges, depending on the particular application.

PVP and dextran are compounds commonly known and readily available from commercial sources. PVP and dextran that have molecular weights from about 10 to about 100,000 Dalton may be suitable. In different embodiments, the molecular weight may vary and may be outside the above range, depending on the particular application.

A CLWA may be a methacrylated hyaluronic acid (MeHA), or another acrylated HA (AHA). The acrylate groups in MeHA are capable of cross-linking the polymerized monomers discussed above, and the pendant HA chain in MeHA provides improved wettability to the resulting material. Other suitable CLWA may also be used. For instance, any WA that includes a functional group (such as an acrylate group) that can cross-link a polymer and includes a hydrophilic functional group (such as a pendant HA chain) that can provide surface hydrophilicity in the resulting material may be suitable.

A n-CLWA may be a hyaluronic acid (HA), polyvinylpyrrolidone (PVP), dextran, or any other suitable wetting agent that is not cross-linkable with the particular polymer used the specification.

In one embodiment, WA 14 is MeHA. In another embodiment, WA 14 includes both MeHA and HA. In a further embodiment, WA 14 includes MeHA and one of PVP and Dextran. In yet another embodiment, WA 14 includes MeHA and a mixture of two or more of n-CLWA.

Conveniently, the incorporation of a CLWA such as MeHA provides a surprising benefit: both the cross-linked and unbonded WA can improve the surface wettability of the material and serve as a wetting agent. Even though the cross-linked MeHA is bonded to the polymer matrix and is not readily releasable therefrom, it provides improved wettability at the lens surface, which is comparable to the improved wettability provided by an unbonded wetting agent such as HA (see e.g. Table II). A convenient benefit of this result is that the cross-linked MeHA can act as a wetting agent without taking up any space in the pores. The pores can then be conveniently fully utilized to load other desired solutions, or additional unbonded wetting agents, such as HA, additional MeHA, PVP, dextran or the like. As the cross-linked MeHA will not be released, good wettability and oxygen permeability can be maintained for the entire lifetime of the lens. Further, reloading of MeHA is not necessary, although loading an additional wetting agent either during manufacture or during use may provide enhanced performance.

The cross-linked WA may also modify the surface properties inside the pores, which can affect the mobility and other transport characteristics of the unbonded WA at or near the inner surfaces of the pores. Thus, the release profile of the unbonded WA may be varied due to the presence of the cross-linked WA. For instance, the cross-linked MeHA may also improve the wettability of inner surfaces of the pores, which may promote both release of unbonded WA that is initially in the pores and re-loading of an aqueous liquid from the surroundings.

One or more of the benefits and advantages discussed in the preceding paragraph or elsewhere herein may still be obtained if MeHA is replaced with another suitable CLWA, such as another AHA.

The choice of a particular WA may depend on the particular application. For example, it may be desirable that the WA be compatible with another material. Further, a WA may be selected to provide increased water binding ability and viscoelastic properties so that the wetting agent can bind more water molecules, or can disperse quickly but remain on the lens or cornea surface for a relatively long period of time. It may also be desirable that WA 14 does not cause significant visual blurring or substantially reduce lens transparency either when it is still dispersed in the lens or when it is released into the eye. Typically, a WA of a higher molecular weight can bind with more water molecules and can support a thicker tear film. Wetting agents that can stabilize tear films may also be advantageous in some embodiments. In some embodiments, HA may be advantageously used as the n-CLWA. For instance, HA may exhibit a longer mean half-life and can better stabilize a pre-corneal tear film than some other wetting agents.

Conveniently, WA 14 incorporated in contact lens 10 can reduce dry eye symptoms or allergic reactions and make wearing the contact lens more comfortable. Due to cross-linking of some of the WA, a relatively large amount of WA can be incorporated into the contact lens material; and good wettability and sustained release of the wetting agent at a relatively high release rate can be maintained over a relatively long period of time such as over more than 20 days. In addition, the contact lens material may exhibit improved mechanical strength as compared to polymeric contact lens materials that contain only a wetting agent that is not cross-linked.

Also conveniently, when MeHA and HA are incorporated, the contact lens materials can exhibit improved biocompatibility to cells such as human corneal epithelial cells (HCEC). For example, it has been shown that HCEC can adhere and grow on the surface of HA/MeHA-loaded contact lens materials.

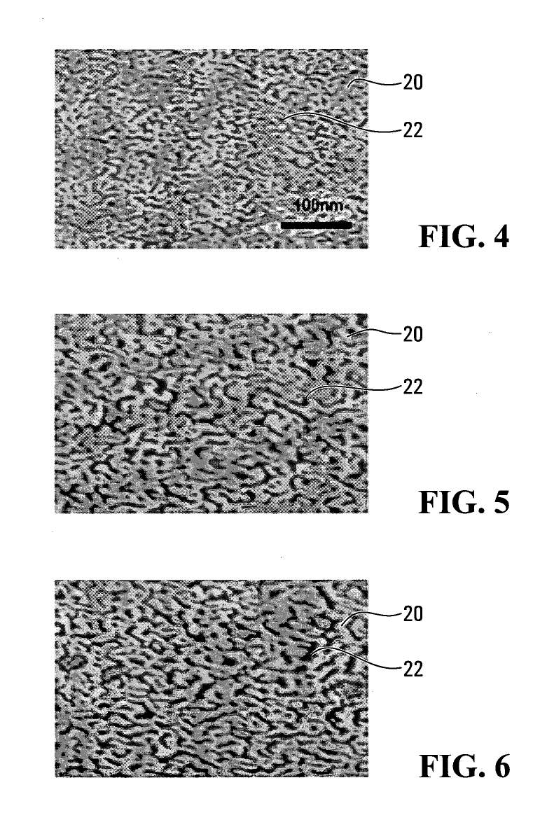

As illustrated in FIGS. 4 to 6, which are representative Scanning Electron Microscopic (SEM) images of the internal structure of sample polymer membranes suitable for use as polymer 12, the polymer has a polymer matrix 20 (shown as the bright portions) defining interconnected elongate pores 22 (shown as the dark portions). Pores are interconnected when at least some of them are joined or linked with each other to form one or more continuous networks. Pores 22 are filled with an aqueous fluid 24 which contains a mixture of water and a WA (not identifiable in the images of FIGS. 4 to 6).

Pores 22 may have round or other cross-sectional shapes and may have different sizes. The pores shown in FIGS. 4 to 6 have pore diameters of about 60 to about 120 nm.

As used herein, a pore diameter refers to the average or effective diameter of the cross-sections of the pores. The effective diameter of a cross-section that is not circular equals the diameter of a circular cross-section that has the same cross-sectional area as that of the non-circular cross-section. In some embodiments, such as when the polymer is swellable when the pores are filled with water, the sizes of the pores may change depending on the water content in the polymer. When the polymer is dried, some or all of the pores may be filled or partially filled by a gas such as air. The polymer may thus behave like a sponge. In some embodiments, the pore diameter may be in the range from about 10 to 100 nm when the polymer is in a dry condition wherein the water content of the polymer is at or near minimum. When the polymer is fully swollen, the pore diameter may be in the range of about 60 to about 120 nm.

Pores 22 may be randomly distributed. Pores 22 may be distributed throughout the porous material. Some of the pores 22 may be closed pores, meaning that they are not connected or joined with other pores or open to the surfaces of the polymer. It is not necessary that all of the pores 22 are interconnected since as more fully discussed below, depending on use, polymers can be prepared to have more or less interconnected pores as would be understood by a skilled person.

Some of the WA molecules incorporated in the contact lens material are cross-linked with the polymer matrix. Initially, water and unbonded WA may be dispersed in the polymer matrix and pores. During use, water and unbonded WA, if present, may be removed or released from the pores and the polymer matrix.

In the materials shown in FIGS. 4 to 6, the aqueous liquid content in the polymer material is about 25 wt % for FIG. 4, about 30 wt % for FIG. 5, and about 35 wt % for FIG. 6. In each case, the aqueous liquid contains about 1 wt % of the WA and the rest is mainly water. For clarity, “wt %” refers to weight percentage on the basis of total weight of the material including the aqueous material.

With reference to FIG. 1, unbounded portion of WA 14 may be releasable from contact lens 10 when it is placed on, and in contact with, an eye. The unbonded WA molecules may diffuse through the liquid phase in the interconnected pores from an inner region to a surface region of polymer 12, such as to surface 16 of contact lens 10. The unbonded WA molecules that are dispersed in polymer 12 may also enter the pores after migrating or diffusing through the polymer matrix.

The release of unbonded portion of WA 14 is facilitated by the interconnected pores and the aqueous liquid in the pores. The release rate of unbonded WA can be controlled in part by altering the size and the degree of interconnection of the pores, and the properties of the liquid in the pores. Thus, polymer 12 can be conveniently used to deliver a wetting agent in a controlled manner during use.

Unbonded WA molecules can travel or migrate within polymer 12 or the pores such as by diffusion. In general, unbonded WA molecules move in random directions but when there is a concentration gradient, there is a net flow of WA molecules from the high concentration region to the low concentration region. WA molecules may travel faster in the pores than in polymer 12 when the pores are filled with a liquid.

Conveniently, the release of the wetting agent can be maintained for a long period of time such as more than 20 days in exemplary embodiments of the present invention because WA 14 is dispersed in the pores and polymer 12, with some cross-linked with the polymer matrix. Initially, WA dispersed in the pores is quickly released at a high release rate. The high release rate may last, for example, a few days. The release rate will then decrease as the initially freely dispersed WA molecules in the pores have already been mostly released. The release of the unbonded wetting agent, however, can continue for a relatively long period of time at a lower release rate, as the unbonded WA dispersed in the polymer slowly move into the pores and diffuse from the inner regions of contact lens 10 to the lens surface.

Conveniently, the cross-linking of a portion of the wetting agent with the polymer matrix may also provide improved strength to the porous material.

When contact lens 10 is worn by a user, the improved wettability of the lens surface can reduce dry eye symptoms, allergic reactions, and discomfort resulting from dry eye conditions and wearing the contact lens. If the optional unbonded WA is present, it can be continuously released into the eye, which may further improve the performance of the contact lens.

In one embodiment, polymer 12 may be prepared by polymerizing a bicontinuous microemulsion that contains one or more copolymerizable monomers, one or more surfactants copolymerizable with at least one of the monomers, water and a WA, such that the resulting polymer has interconnected pores filled with an aqueous liquid. The WA is dispersed in the mirroemulsion before polymerization, such as in the aqueous domains. The microemulsion may also include a polymerization initiator, such as a photo initiator. Conveniently, at least a portion of the WA also serves as a cross-linker. Thus, in some embodiments, no additional cross-linker is required. In other embodiments, an additional cross-linker may be included in the microemulsion.

For clarity, “microemulsion” refers to a thermodynamically stable dispersion of one liquid phase into another liquid phase. The microemulsion may be stabilized by an interfacial film of surfactant. One of the two liquid phases is hydrophilic or lipophobic (such as water) and the other is hydrophobic or lipophilic (such as oil). Typically, the droplet or domain diameters in microemulsions are about 100 nanometers or less, and thus the microemulsions are transparent. In a bicontinuous microemulsion, each of the two liquid phases is continuous.

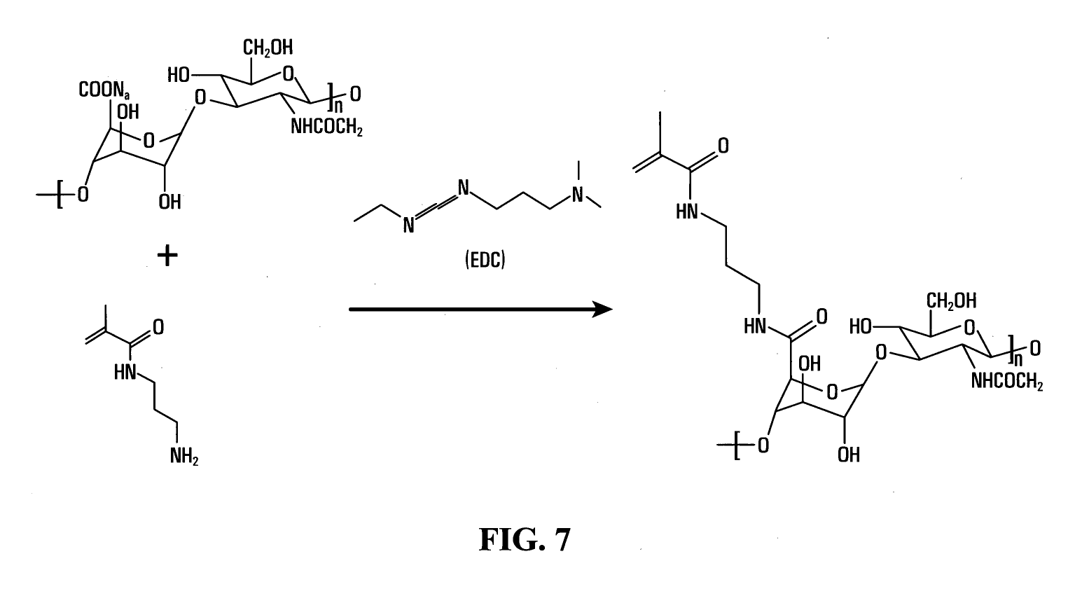

The WA includes a CLWA, which may be MeHA, such as the one shown in FIG. 3. The MeHA shown in FIG. 3 can be prepared according to the reaction route illustrated in FIG. 7. The manufacture of MeHA according to FIG. 7 is known to persons skilled in the art. Briefly, a primary amine group of atactic poly methyl methacrylate (aPMMA) is conjugated to carboxylic acids in hyaluronan by using 1-Ethyl-3-[3-dimethylaminopropyl]carbodiimide Hydrochloride (EDC) and 1-hydroxybenzotriazole (HOBt) as coupling agents. The preparation of MeHA is also discussed in the literature such as in M. A. Princz et al., “Release of wetting agents from Nelfilcon contact lenses”, Invest Ophthalmol. Vis. Sci. 2005; 46:E-Abstract 907 (hereinafter “Princz”); and M. R., Kim and T. G. Park, “Temperature-responsive and degradable hyaluronic acid/Pluronic composite hydrogels for controlled release of human growth hormone,” Journal of Controlled Release, 2002, vol. 80, pp. 69 to 77(9), the relevant contents of each of which are incorporated herein by reference.

The WA may also include a HA, such as one having the formula shown in FIG. 2, which is available from commercial chemical providers, such as Chisso Corporation of Japan. The HA can also be prepared based on the techniques disclosed in, for example, in P. A. Band, “Hyaluronan derivatives: chemistry and clinical applications”, in The Chemistry, Biology and Medical Applications of Hyaluronan and Its Derivatives, T. C. Laurent ed., Portland Press Ltd., London, UK, 1998, pp. 33-42, the relevant contents of which are incorporated herein by reference.

As discussed above, PVP and dextran are common chemicals readily available from commercial sources.

The monomers for forming the bicontinous microemulsion can be any suitable monomer known to persons skilled in the art, which is capable of copolymerizing with another monomer to form a copolymer. While the monomer is copolymerizable with another monomer such as the surfactant, the monomer may also be polymerizable with itself. The type and amount of the monomer that may be employed to prepare a suitable bicontinous microemulsion will be known to a skilled person. Exemplary monomers are ethylenically unsaturated monomers including MMA, HEMA, 2-hydroxylethyl acrylate, monocarboxylic acids such as M and MA, GMA, and silicone-type monomers. Suitable combinations of these monomers can also be used.

A polymerizable surfactant is capable of polymerizing with itself or with other monomeric compounds to form a polymer. The surfactant for the mixture can be any suitable surfactant that can co-polymerize with at least one of the monomers in the microemulsion. As can be appreciated, when the surfactant is copolymerized into the polymer, there is no need to separate the surfactant from the polymer after polymerization. This can be advantageous as the polymer formation process is simplified.

In one embodiment, the surfactant is a zwitterionic surfactant. For some applications, zwitterionic surfactants may be advantageous. For instance, it is expected that the inclusion of a zwifterionic surfactant may allow adjustment of the WA release profile through variation of pH in the microemulsion. The zwitterionic surfactant may be 3-((11 -acryloyloxyundecyl)-imidazolyl) propyl sulphonate (AIPSA), or SO₃⁻(CH₂)ₘ⁺NCHCHCHN(CH₂)ₙV, where m is an integer ranging from 1 to 20, n is an integer ranging from 6 to 20, x is an integer ranging from 10 to 110, and V is (methyl)acrylate or another copolymerizable unsaturated group.

In different embodiments, other suitable surfactants, such as those disclosed in Chow, may be used. In some embodiments, a nonionic or anionic surfactant may be used. For example, a suitable nonionic surfactant may include PEO (polyethyleneoxide) groups (such as from about 15 to about 110), and a suitable anionic surfactant may include sulfonate and carboxylate groups.

AIPSA may be synthesized as follows. 11-hydroxyundecylimidazole is formed by reacting 11-bromoundecanol with imidazole by a S_{N}2 reaction mechanism and then subjected to sulphonation of precursor intermediate using 1,3 propane-sultone to the corresponding sulphonate (3-((11-hydroxyundecyl)-imidazolyl)propyl sulphonate). Finally, an acrylate group is added to the precursor sulphonate to produce AIPSA with a polymerizable group located at the “tail” of the molecule. The preparation of AIPSA is also discussed in the literature such as in L. Liu et al., “Wetting agent release from contact lenses”, Invest Ophthalmol Vis. Sci. 2005; 46:E-Abstract 908 (hereinafter “Liu”), the relevant contents of which are incorporated herein by reference.

As used herein, an ingredient compound used in the formation of the lens material includes both the base compound and its suitable salts or derivatives. For instance, MeHA may be both the compound shown in FIG. 3, and any suitable salt or derivative of that compound. A suitable derivative is a derivate of the base compound that retains the characteristic functional group(s) of the base compound and thus provide(s) the same characteristic functionality of the base compound. For example, a suitable derivative of MeHA may be one that retains the functional group for cross-linking with the polymer and the HA chain for improving surface wettability.

The preparation of microemulsions is generally known in the art. For instance, an exemplary procedure for preparing similar bicontinuous microemulsion is described in PCT Patent Application Publication No. WO2006/014138 to Chow et al. (hereinafter referred to as “Chow”), published Sep. 2, 2006, the entire contents of which are incorporated herein by reference. With the modifications described herein and in accordance with aspects of the present invention, the membrane material for contact lens 10 may be prepared according to the procedure described in Chow.

In one embodiment, the bicontinuous microemulsion may be prepared as follows. A mixture of the components for the microemulsion may be dispersed to form a microemulsion by standard techniques such as sonication, vortexing, or other agitation techniques for creating microdroplets of the different phases within the mixture. Alternatively, the mixture may be passed through a filter having pores on the nanometer scale so as to create fine droplets. Depending on the proportions of various components and the hydrophile-lipophile value of the surfactant, the droplets can be swollen with oil and dispersed in water (referred to as normal or O/W microemulsion), or swollen with water but dispersed in oil (referred to as inverse or W/O microemulsion), or the microemulsion can be bicontinuous. In the present embodiment, the components and their proportions are selected so that a bicontinuous microemulsion is formed for preparing polymer 12.

The structure of the bicontinuous microemulsion may be similar to those described in Chow. In the microemulsion, there are oil domains which contain the monomers and aqueous domains which contain the aqueous fluid. These domains are randomly distributed and respectively interconnected, extending in all three dimensions. When the oil domains are polymerized, the presence of the aqueous domains results in interconnected pores filled with the aqueous fluid that was present in the aqueous domains. The WA is initially dispersed in the aqueous fluid and at least some of the CLWA will be cross-linked with the polymer during polymerization.

The choice and weight ratio of the particular monomer and surfactant for a given application may depend on the application. Generally, they should be chosen such that the resulting polymer is suitable and compatible with the environment in which the polymer is to be used and has the desired properties.

The water in the microemulsion can be pure water or a water-based liquid. As discussed, the WA may be initially dispersed or dissolved in the water. The water may optionally contain various other additives having specific properties. Such additives can be selected for achieving one or more desired properties in the resulting polymer, and can include one or more of a drug, a protein, an enzyme, a filler, an inorganic electrolyte, a pH adjuster, and the like.

As will be understood by a skilled person in the art, a nanoporous and transparent polymer matrix can be obtained when the components of the micrnemulsion are in appropriate ratios and the droplets or domains have appropriate sizes. As is known to persons skilled in the art, to determine the appropriate proportions of the components suitable for forming a bicontinuous microemulsion, a ternary phase diagram for the monomer, water and the surfactant may be prepared. The region on the diagram corresponding to single-phase microemulsion may be identified and the proportions of the components may be so chosen such that they fall within the identified region. A person skilled in the art will be able to adjust the proportions according to the diagram in order to achieve a certain desirable property in the resulting polymer. Further, the formation of a bicontinous microemulsion can be confirmed using techniques known to persons skilled in the art. For example, the conductivity of the mixture may increase substantially when the microemulsion is bicontinuous. The conductivity of the mixture may be measured using a conductivity meter after titrating a 0.1 M sodium chloride solution into the mixture.

Suitable bicontinuous microemulsions can be formed when proportions of the components are respectively from about 15 to about 50 wt % for the aqueous liquid (including water and WA), from about 5 to about 40 wt % for the monomer(s), and from about 10 to about 50 wt % for the surfactant(s). The aqueous liquid may contain mainly water. The WA content in the microemulsion may vary from about 0.1 to about 0.5 wt %, such as from about 0.25 to about 0.35wt %. In one embodiment, MeHA is used as the CLWA and the MeHA content may be about 0.25 wt %. A mixture of MeHA and HA may also be used, with a total content of about 0.25 to 0.35 wt %. The WA may be dispersed or dissolved in the aqueous liquid.

Persons skilled in the art will understand how to combine different monomers and surfactants in different ratios to achieve the desired effect on the various properties of the resulting polymer, for example to improve the mechanical strength or hydrophilicity of the resulting polymer.

The polymer should also be safe and biocompatible with human cells and human eyes. It is desirable that the polymer is permeable to fluids such as gases (e.g. O₂ and CO₂), various salts, nutrients, water and diverse other components of the tear fluid. The presence of nanopores distributed in the polymer facilitates the transport of gases, molecules, nutrients and minerals to the eye or the surroundings. It will be appreciated that the exemplary polymers according to some embodiments of the present invention can provide a controlled and long-lasting delivery of a loaded wetting agent or other fluid material.

The amount of WA (and CLWA) included in the microemulsion can be determined based on various factors. In general, one factor is that the concentration of WA (CLWA) should be high enough for providing desired surface wettability, and optionally desirable rate of release of unbonded wetting agent during use. Generally, higher loading will result in higher release rate. The transparency and clarity of the resulting polymer material is another factor. A very high WA loading may affect the phase equilibrium of the microemulsion precursor and the resulting polymer material may not be sufficiently transparent. Tests show that, in some embodiments, transparent polymers can be prepared when up to about 0.35 wt % HA or MeHA is contained in the microemulsion. A further factor is the mechanical properties of the resulting polymer. Experiments show that the concentration of CLWA can affect the polymer's mechanical properties. In some embodiments, improved mechanical properties can be achieved when the concentration of the CLWA is from about 0.1 to 0.35 wt %. The microemulsion is polymerized to form a transparent and porous polymer wherein the WA is dispersed in the polymer and the pores, and at least some of the CLWA molecules are cross-linked with the polymer.

The microemulsion may be polymerized using a standard technique known to a skilled person. For example, it may be polymerized by heat, the addition of a catalyst, by irradiation of the microemulsion, or by introduction of free radicals into the microemulsion. The method of polymerization chosen will be dependent on the nature of the components of the microemulsion.

Polymerization of the microemulsion may involve the use of a catalyst. The catalyst may be any catalyst or polymerization initiator that promotes polymerization of the monomers and the surfactant. The specific catalyst chosen may depend on the particular monomers, and polymerizable surfactant used or the method of polymerization. For example, polymerization can be achieved by subjecting the microemulsion to ultraviolet (UV) radiation if a photo-initiator is used as a catalyst. Exemplary photo-initiators include 2,2-dimethoxy-2-phenyl acetophenone (DMPA) and dibenzylketone. A redox-initiator may also be used. Exemplary redox-initiators include ammonium persulphate and N,N,N′,N′-tetramethylethylene diamine (TMEDA). A combination of photo-initiator and redox-initiator may also be used. In this regard, including in the mixture an initiator can be advantageous. The polymerization initiator may be about 0.1 wt % to about 0.4 wt % of the microemulsion.

Conveniently, the CLWA cross-links the polymer. However, to further promote cross-linking between polymer molecules in the resulting polymer, an additional cross-linker may be added to the mixture. Suitable cross-linkers include ethylene glycol dimethacrylate (EGDMA), diethylene glycol dimethacrylate and diethylene glycol diacrylate, and the like. Generally, the more the polymer molecules are cross-linked, the more difficult it is for dispersed wetting agent to diffuse or migrate through the polymer, thereby resulting in a slower release of the wetting agent. The content of the cross-linker can therefore be selected to adjust the release rate. Increasing the overall concentration of the cross-linker can also improve the mechanical strength of the resulting polymer.

As discussed above, the CLWA such as MeHA is itself a cross-linker and, as such, it is not necessary to include another cross-linker. Since the CLWA can serve both as a wetting agent and as a cross-linker, it may be advantageous to use CLWA in comparison with using separate cross-linkers and wetting agents. Including the CLWA may also provide flexibility and may be advantageous since the amount of additional cross-linker to be added may be reduced without reducing the overall cross-linking of the polymer molecules.

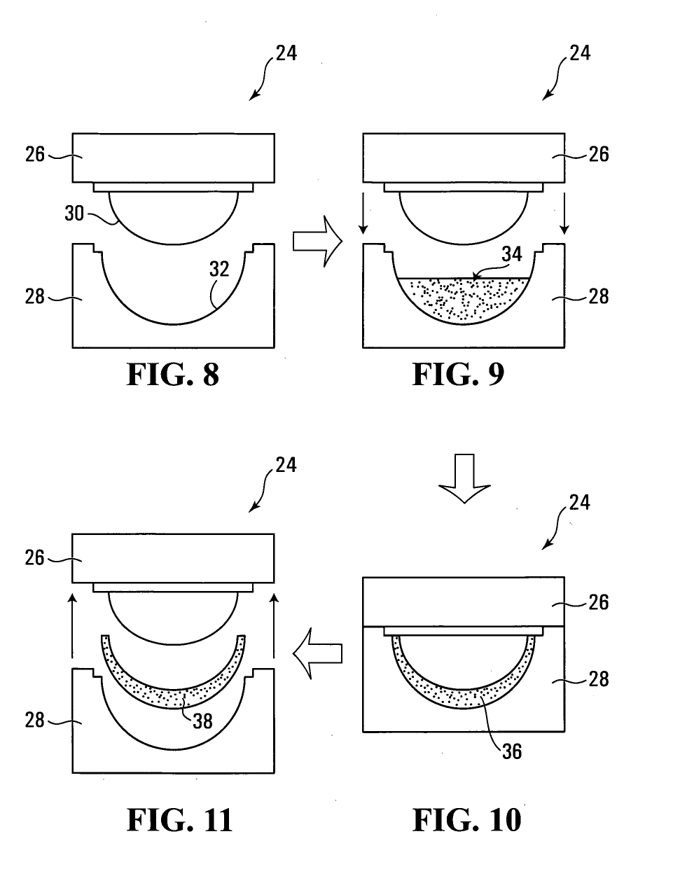

The microemulsion may be formed into a desired end shape and size prior to polymerization. In one embodiment, contact lens 10 may be formed from the microemulsion according to the process illustrated in FIGS. 8 to 11.

As shown in FIG. 8, a mould 24 is provided, which includes a male portion 26 and a female portion 28. Male and female portions 26 and 28 can be detachably coupled. The inner surface 30 of male portion 26 is convex shaped and the inner surface 32 of female portion 28 is correspondingly concave shaped so that when the male and female portions are coupled together the inner surfaces 30 and 32 define a desired profile for the content lens.

As shown in FIG. 9, a suitable amount of the prepared microemulsion 34 is first deposited into female portion 28. Male portion 26 is then coupled to female portion 28 to compress microemulsion 34 into the desired shape 36 defined by inner surfaces 30 and 32, as shown in FIG. 10.

Alternatively, male and female portions 26 and 28 may be first coupled and the microemulsion may be then injected into the cavity of the mould. For this purpose, an injection port (not shown) may be provided.

Microemulsion 36 in mould 24 is then subject to polymerization reactions. Polymerization may be effected by irradiation such as Ultraviolet (UV) irradiation. The monomers are then polymerized to form a polymer material as described above.

As shown in FIG. 11, the resulting polymer forms a contact lens 38 which has the desired shape. Contact lens 38 may be removed from mould 24 after polymerization.

Contact lens 38 may be rinsed and equilibrated with water to remove unreacted monomers and WA that has not been incorporated into the polymer. A small percentage of the WA dispersed in the pores of contact lens 38 may be lost during rinsing but the amount lost can be limited by limiting the duration and extent of rinsing. Further, to compensate for the WA lost during rising, the initial concentration of WA in the microemulsion may be selected so that the final concentration of WA in contact lens 38 provides the desired rate of release.

Optionally, the rinsed polymer material may be dried and sterilized in preparation for storage or future use. Both drying and sterilization can be accomplished in any suitable manner known to persons of skill in the art. In some embodiments, both drying and sterilization can be effected at a low temperature, for example using an ethyleneoxide gas or UV radiation, so as not to adversely affect the WA dispersed in the polymer material.

The unbonded WA in contact lens 10 or 38 can be released over an extended period from the polymer when the polymer is in contact with an eye. The release rate of WA can be controlled by selecting the appropriate monomers and their proportional amounts.

Contact lens 10 or 38 can be used for vision correction, eye color modification, or as diabetic contact lenses.

Conveniently, the contact lens material according to various embodiments of the invention can be made compatible with human dermal fibroblasts cells and mechanically strong and can be advantageously used to manufacture contact lenses for placement on the eye.

The polymeric materials described above are useful not only for contact lens applications, but also useful in other applications. For example, the exemplary materials and processes described herein, or similar materials or processes, may be utilized to prepare hydrophilic, nanoporous materials for use in applications such as prescription lenses, 3-D (dimensional) tissue engineering scaffolds, artificial cornea, or the like.

These polymeric materials can have various desirable physical, chemical, and biochemical properties. To illustrate, the preparation and properties of sample polymeric materials are described below.

### Examples

### Example I

### Preparation of Component Materials

The materials used in the Examples were obtained or prepared as follows.

Sodium hyaluronate (HA) was obtained from Chisso Corporation of Japan.

2-hydroxyethylmethacrylate (HEMA), methyl methacrylate (MMA) and ethyleneglycol dimethacrylate (EGDMA) were obtained from Aldrich™ and further purified under reduced pressure before use.

2,2-dimethoxy-2-phenyl acetophenone (DMPA) was obtained from Aldrich™ and was used as received.

Water used in all sample microemulsions was deionized and distilled.

The polymerizable zwitterionic surfactant, 3-((11-acryloyloxyundecyl)-imidazolyl)propyl sulphonate (AIPSA), was synthesized as described below, according to the procedure described in Liu.

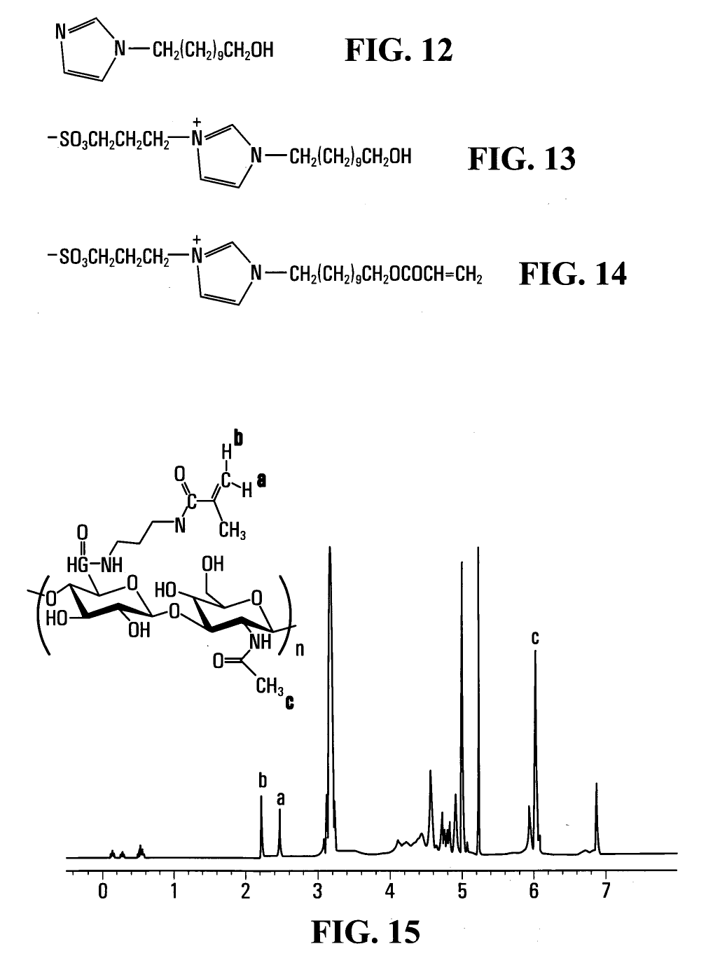

11-hydroxyundecylimidazole (HUI), with the formula shown in FIG. 12, was prepared as follows. A solution of 11-bromoundecan-1-ol (25.0 g, 0.1 mol), imidazole (0.08 mol) and 4 g of sodium hydroxide pellets (dissolved in 6 ml of water) in 200 ml of ethanol was refluxed for 6 hours. Upon cooling the solution to room temperature, the precipitate was filtered out and the ethanol solvent was evaporated from the filtrate. After evaporating off the ethanol, the residue was dissolved in ether, washed twice with water and left to dry overnight by magnesium sulfate. After filtration, the filtrate was cooled to allow a white product to precipitate from the solution. The white solid product was obtained and dried to a constant weight in vacuum.

3-((11-hydroxyundecyl)-imidazolyl) propyl sulphonate (HUIPS), with the formula shown in FIG. 13, was prepared as follows. To a magnetically stirred solution of 11-hydroxyundecylimidazole (0.1 mol) in 200 ml dried acetonitrile, 1,3 propane-sultone (0.1 mol) was added dropwise over 30 minutes. The solution was refluxed for one day under nitrogen atmosphere. The product precipitated out from the reaction mixture and was extracted by filtration. The product was then dried in a vacuum oven for one day at ambient temperature.

3-((11-acryloyloxyundecyl)-imidazolyl)propyl sulphonate (AIPSA), with the formula shown in FIG. 14, was then prepared as follows. A mixture was formed by adding acryloyl chloride (0.3 mol) slowly to a magnetically stirred solution of HUIPS (0.1 mol) in dried acetonitrile (200 ml) at about 0° C. The solution had been purged with N₂gas. The mixture was allowed to further react at room temperature for about 3 days. The mixture was then filtered and excess acryloyl chloride and acetonitrile were removed in a rotary evaporator. The residue was dissolved in distilled chloroform, washed twice with a saturated sodium bicarbonate solution, followed by saturated brine, and dried overnight by magnesium sulfate. A pure product of AIPSA was obtained by re-precipitating the crude product in anhydrous ether. The precipitate was filtered out and dried in a vacuum oven.

The ¹H NMR spectra of the precursor intermediates and the surfactant so prepared were measured, and assigned as follows:

HUI:

(300 MHz, CDCl₃): δ (in ppm)=1.11-1.7 m (18H, —CH₂—(CH₂)₇—CH₂—), 3.6 t (2H, —CH₂—O), 4.0 t (2H, N—CH₂—), 6.9-7.1 d/7.8 s (1H, each C₃N₂H₃

HUIPS:

(300 MHz, D₂O): δ (in ppm)=1.11-1.7 m (18H, —CH₂—(CH₂)₇—CH₂—), 2.4 m (2H, S—C—CH₂—C—N), 2.9 t (2H, —CH₂—S), 3.6 t (2H, —CH₂—O), 4.4 t (2H, —N—CH₂), 4.2 t (2H,—N⁺—CH₂—), 7.5-7.6 d/8.8 s (1H, each C₃N₂H₃);

AIPSA:

(300 MHz, D₂O): δ (in ppm)=1.11-1.7 m (18H, —CH₂—(CH₂)₇—CH₂—), 2.4 m (2H, S—C—CH₂—C—N), 2.8 t (2H, —CH₂—S), 4.1t (2H, —CH₂—O), 4.4 t (2H, —N—CH₂—), 4.2 t (2H, —N⁺—CH₂—), 5.9-6.4 d (2H, ═CH₂), 6.1 d,d (1H, ═CH), 7.5, 7.6 d/8.8 s (1H, each C₃N₂H₃).

### Example II

### Synthesis of MeHA

MeHA was synthesized based on the reaction route shown in FIG. 7 as described below and according to the procedure disclosed in Princz.

Sodium hyaluronate (500 mg, 2.85310 mmol) and aPMMA (472 mg, 2.64 mmole, two-fold molar excess relative to —COOH in sodium hyaluronate) were dissolved in 150 ml of deionized water (pH 6.8). EDC (252.8 mg, 1.32) and HOBt (178 mg, 1.32 mmol) dissolved in 10 ml of a 1:1 mixture of dimethylsulfoxide and water were added into the above solution. The stoichiometric ratio of —COOH in Sodium hyaluronate/EDC/HOBt was 1:1:1. Conjugation reaction was allowed to occur in the solution for one day. The reaction product, aPMMA derivatized HA, was dialyzed against deionized H₂O for 12 hours (Mw cut-off 10 000) and then was freeze-dried. Percent modification of HA by aPMMA was determined by analyzing the ¹H-NMR spectra, which was shown in FIG. 15.

The substitution degree of HA was calculated by comparing the relative peak intensity ratio between two protons of the vinyl group in aPMMA (═CH₂, 5.5, 5.8 ppm) and three protons in the methoxy group of HA (—C═OCH₃, 2.1 ppm). The degree of substitution was found to be from about 30 to about 33%.

### Example III

### Sample Microemulsions

Sample microemulsions I to IX were prepared. The compositions of the precursor solutions for the sample microemulsions are listed in Table I. Each sample contained a bicontinuous microemulsion, with various concentrations of monomers (HEMA/MMA), surfactant AIPSA, and an aqueous content which included water and optionally HA or MeHA. A cross-linker, EGDMA, was added to each precursor solution, in the amount of about 5 wt % based on the total weight of all polymerizable monomers, for increasing the mechanical strength of the resulting membrane formed from the microemulsion. About 1 wt % of DMPA was also added based on the total weight of all polymerizable monomers in each sample.

TABLE I
Precursor Solutions for Sample Microemulsions

| Sample | | Precursor Composition (wt %) | | |
|---|---|---|---|---|
| No. | Name | Water (HA/MeHA) | HEMA/MMA | AIPSA |
| I | W25-0.25HA | 25.0 (0.25) | 37.5 | 37.5 |
| II | W30-0.30HA | 30.0 (0.30) | 35.0 | 35.0 |
| III | W35-0.35HA | 35.0 (0.35) | 32.5 | 32.5 |
| IV | W25-0.25MeHA | 25.0 (0.25) | 37.5 | 37.5 |
| V | W30-0.25MeHA | 30.0 (0.25) | 35.0 | 35.0 |
| VI | W35-0.25MeHA | 35.0 (0.25) | 32.5 | 32.5 |
| VII | W25 | 25.0 | 37.5 | 37.5 |
| VIII | W30 | 30.0 | 35.0 | 35.0 |
| IX | W35 | 35.0 | 32.5 | 32.5 |

Sample membranes were then formed from these microemulsion samples as follows.

For each sample, about 1 g of the microemulsion was prepared in a screw-capped tube. The microemulsion was ultrasonicated for 20 seconds to eliminate tiny bubbles formed during mixing of its components. The gel-like pre-polymerized microemulsion was then spread over and sandwiched between two 20 cm×20 cm glass plates, which were previously washed and dried at room temperature. A membrane was formed after the microemulsion between the glass plates was subjected to further polymerization in a photoreactor chamber at about 35° C. for about 2 hours. For all samples listed, the membranes formed were transparent and had high mechanical strength.

The morphology of the sample membranes were confirmed by SEM micrographs, some of which are shown in FIGS. 4 to 6. As can be observed from these figures, the material has a bicontinuous and nanoporous network. The estimated average pore diameters range from about 60 to about 120 nm, depending on the initial water content in the microemulsion formulation. The pores in samples formed with a water content of 35 wt % were much larger than the ones that were formed with a smaller water content.

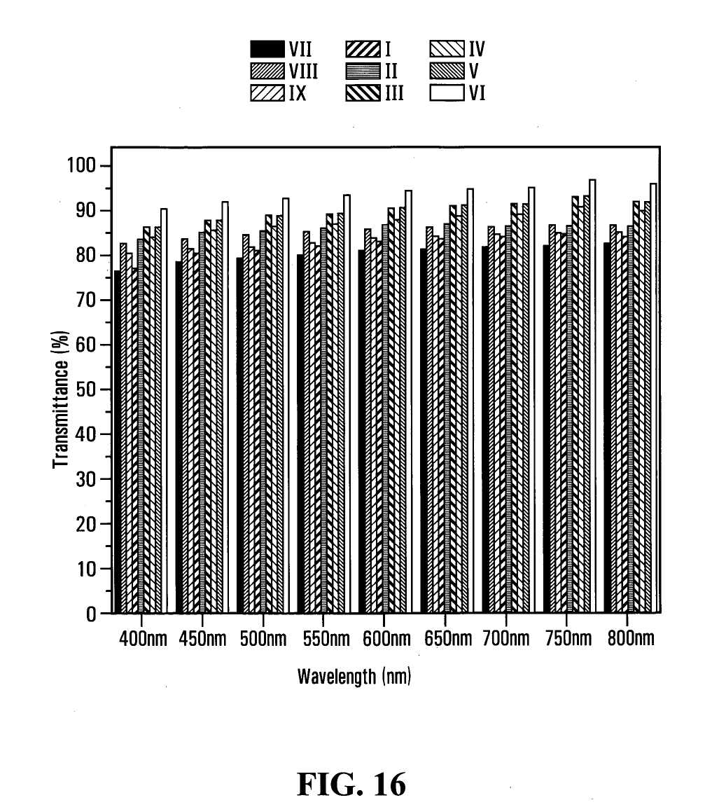

Transparency of the sample materials was also measured and the results were summarized in FIG. 16, which also compares the transparency of HA/MeHA loaded membranes with other materials that do not contain a WA. The results indicate that the HA/MeHA-loaded membranes had similar transparency as that of native corneas or commercially available contact lenses.

### Example IV

### In Vitro HA Release

Release of HA from the HA-loaded sample membranes were measured.

Sample membranes formed from each sample microemulsion with HA were placed in three separate 5-ml vials which contained PBS buffer. The vials were placed in an incubator at 34° C. with a rotating rate of 50 rpm. At each one-hour interval, 1-ml portions of the solutions was drawn from the vials for UV-VIS spectrophotometric assay. After each withdrawal, 1-ml of fresh PBS buffer was added to the vial to maintain the 5-ml total volume. This process continued until no further released WA was detectable.

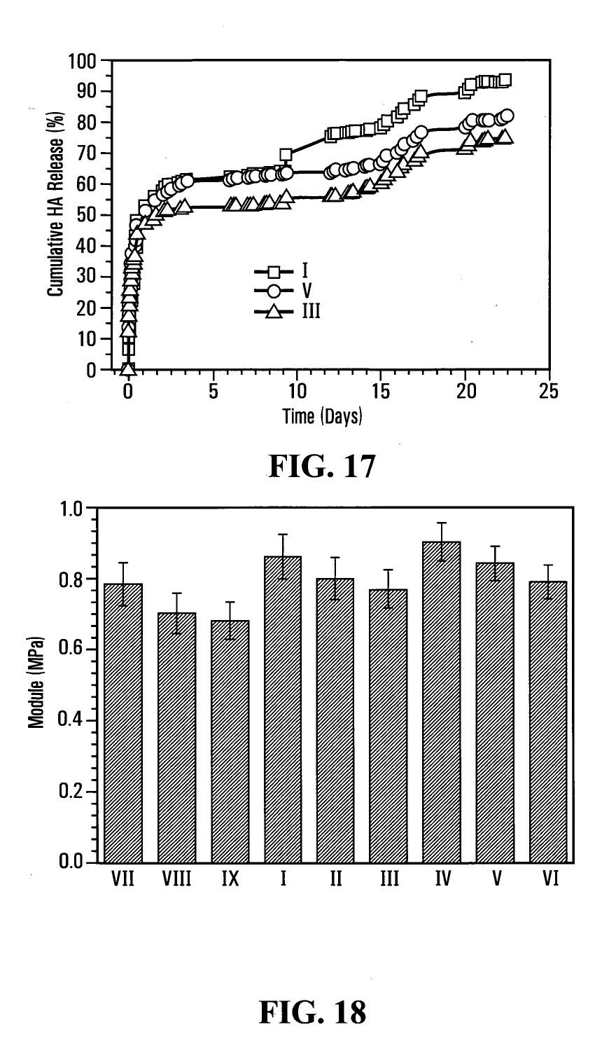

FIG. 17 shows the measured results of in-vitro HA release, as a function of time. The results shown indicate cumulative HA release characteristics. Sample membranes with higher HA and water content exhibited relatively faster release. The release rate for each sample reached a plateau within 4 days, after which the release rate was relatively low but remained at a relatively stable rate for 10 to 20 days. This release profile was likely due to the higher HA concentration and larger pore sizes of the lens material with higher initial water content in the lens formulation. The release rate also increased with increasing HA content in the microemulsion formulation.

### Example V

### Dynamic Mechanical Analysis

The storage moduli and glass transition temperature of the sample membranes were measured in triplicates by a Dynamic Mechanical Analyzer (TA Instruments, DMA 2980). Some of the measured results are shown in FIG. 18.

The dynamic mechanical analysis showed changes on the storage modulus of sample membranes with different water and HA/MeHA content. The modulus can affect the conformability of the lens material and hence can impact on the comfort of the user wearing contact lenses formed from the particular material. The strength of the contact lens material will affect the handling and tearing characteristics of the contact lens. As shown in FIG. 18, with the same initial water content, HA/MeHA-loaded samples exhibited higher modulus than samples that had no HA or MeHA loading. Among the samples tested, MeHA-loaded samples exhibited relatively higher modulus. Further, within the tested range, the storage modulus increased when the water content was increased.

### Example VI

### Contact Angle Measurement

The dynamic water contact angles of the sample membranes were measured using Kruss™ Tensiometer (K14, KRÜSS, Germany) with a thermostated water bath. The samples loaded with WA were measured before the unbonded welting agent in the samples have been removed. The measurements were repeated three times and the results were averaged and listed in Table II.

The surface contact angles were used to evaluate the surface wettability of the lens materials. A measure of surface wettability is its advancing contact angle (θ_{A}). Another useful measure was the hysteresis of its contact angle which is the difference between the advancing contact angle and the receding contact angle (θ_{R}). As illustrated in Table II, both smaller contact angles and hysteresis were exhibited by samples that contained HA/MeHA as compared to samples without HA/MeHA loading. This indicates that the MeHA/HA-loaded materials have enhanced hydrophilicity. Further, the MeHA-loaded materials exhibited the lowest hysteresis. In contrast, sample materials without a WA exhibited very high hysteresis (more than 40°).

TABLE II
Dynamic Water Contact Angles

| Sample Formulation | | θ_{A} (°) | θ_{R} (°) | Hysteresis (°) |
|---|---|---|---|---|
| I | W25-0.25HA | 50.7 ± 5.3 | 40.3 ± 6.0 | 12.9 |
| II | W30-0.30HA | 46.3 ± 4.5 | 38.1 ± 8.0 | 8.2 |
| III | W35-0.35HA | 43.5 ± 7.5 | 37.5 ± 3.5 | 6.0 |
| IV | W25-0.25MeHA | 51.6 ± 5.5 | 42.8 ± 4.0 | 8.8 |
| V | W30-0.25MeHA | 49.2 ± 4.4 | 40.9 ± 2.0 | 8.3 |
| VI | W35-0.25MeHA | 46.7 ± 3.6 | 39.7 ± 7.0 | 7.0 |
| VII | W25 | 86.3 ± 7.5 | 42.8 ± 8.0 | 43.5 |
| VIII | W30 | 82.3 ± 9.1 | 41.5 ± 6.8 | 40.8 |
| IX | W35 | 80.4 ± 5.3 | 39.8 ± 4.8 | 40.6 |

### Example VII

### Cell Culture and Viability Assay

Human corneal epithelium cells (HCEC) (Cascade Biologics, USA) were cultured on sample membranes in supplemented EpiLife™ Medium (human corneal growth supplement, antibiotics and antimycotics)) and incubated at 37° C. in a humidified atmosphere with 5% CO₂, until the cells had adapted to the new culture conditions. The morphology of the cells was monitored and photographed under a phase-contrast microscopy (AVIOVERT™, ZEISS, Germany) and equipped with a camera (Nikon™ 4500). The primary human corneal epithelial cells were seeded onto the samples at a density of 15,000 cells/ml in the culture medium. The number of viable cells attached on the membranes was analyzed by employing DAPI (4′,6-diamidino-2-phenylindole) staining.

The morphology of cultured HCEC was studied after 4 days of culture on sample lens material. DAPI staining and fluorescent quantum dots were used to label the nuclei and cell cytoplasm of the living cells. The samples were imaged and the images showed that the HCEC cells adhered to the sample membrane, and covered the membranes' surface. This indicates that the sample materials were able to serve as a bioactive membrane for cell growth without further processing. This represented an improvement compared to existing polymer surfaces used for artificial cornea purpose since the conventional polymer membranes failed to show cell adherence without an extracellular matrix (ECM) surface coating.

### Example VII

### Sample Contact Lens

Sample contact lenses were prepared from the sample microemulsions by injecting 70 μl of the corresponding sample microemulsion formulation into a mould as illustrated in FIG. 10. Care was taken to not entrap air bubbles in the mould. The microemulsions were UV cured under UV lamps operating between 5 and 15° mW/cm² for about 30 minutes at 37° C. After curing, the cured lens material were taken out from the mould. The cured materials were polymerized and clear. The lenses had a cornea-shape. The lenses were then immersed in buffered saline until the lenses were swollen to equilibrium.

The properties of the sample lenses were measured and some of the results were summarized in Table III.

TABLE III
Properties of Sample Contact Lenses

| | | Thickness | EWC | Expansion | |
|---|---|---|---|---|---|
| Sample Formulation | | (μm) | (%) | Factor | Dₖ |
| I | W25-0.25HA | 89.6 | 55 | 1.19 | 24 |
| II | W30-0.30HA | 93 | 60 | 1.24 | 28 |
| III | W35-0.35HA | 83.2 | 65 | 1.29 | 30.4 |
| IV | W25-0.25MeHA | 85.4 | 53 | 1.14 | 16.9 |
| V | W30-0.25MeHA | 80.4 | 59 | 1.21 | 18.8 |
| VI | W35-0.25MeHA | 90.8 | 62 | 1.25 | 21.1 |
| VII | W25 | 85.4 | 50 | 1.10 | 9.27 |
| VIII | W30 | 99.2 | 55 | 1.18 | 11.8 |
| IX | W35 | 90.4 | 60 | 1.22 | 14.5 |

The oxygen permeability (Dk) of the sample lenses or lens materials were determined using the OptiPerm^{SM} Technology for measuring the Dk value of hydrophilic contact lenses. Measurements were made with 5 different samples for each sample material, and the average results were used for further analysis. The results show that Dk values of the sample lens materials that contained HA or MeHA were higher, thus better, than those of sample lens materials that did not contain HA. The value of Dk also varied with the concentration of WA in the final lens formulation within a certain range. Above a certain threshold of WA concentration, the value of Dk was controlled by the absolute water content in the formulation. Thus, it was shown that the addition of a suitable amount of HA or MeHA to the formulation can adjust the oxygen permeability characteristics of the resulting lens material.

To measure the equilibrium water content (EWC), the sample lens materials (membranes) were completely dried in vacuum at room temperature until a constant weight was attained. The dried membranes were immersed in water at 30° C. until the swelling equilibrium was reached. The swollen membranes were blotted lightly to remove excess surface ethanol or water and were then weighed. The EWC was expressed as a percentage calculated as:

$$EWC ( \% ) = \frac{Ws - W}{Ws} \times 100 ,$$

where Ws is sample weight at swelling equilibrium and W is the dry sample weight. The results show that EWC increased with both water and WA contents in the sample formulations. The sample materials with MeHA/HA had enhanced hydrophilicity as compared to other tested materials that did not contain MeHA/HA. The high water absorption ability exhibited by some of the sample membranes is expected to be due to several factors. First, these sample membranes may have high affinity to water due to their high hydrophilicity. Second, the sample membranes had increased porosity when the water content in the microemulsion formulation was increased.

The expansion factor for the sample membranes also increased with increasing water content in the precursor microemulsion, as more water could be absorbed due to the hydrophilicity nature of the polymerized membranes, in addition to water that was already present in the membrane pores. The expansion factor may be measured by measuring the size, such as the diameter, of the lens.

Other wetting agents, such as polyvinylpyrrolidone (PVP) or dextran or the like, are expected to similarly exhibit some of the improvements and benefits shown by HA and MeHA. However, HA or MeHA may provide additional benefits over such other wetting agents. For example, HA or MeHA can maintain relatively high viscosity without causing residue formation, blurring or friction. Further, MeHA/HA can play a role in enhancing cell growth, cell differentiation, cell migration, and the like. Conveniently, when MeHA is cross-linked in the polymer of embodiments of the present invention, degradation of the wetting agent is reduced as compared to in polymers where the WA is not cross-linked. Thus, the stability of WA in the contact lens is improved and performance can remain relatively stable over a long period of time. In comparison, some wetting agents such as HA when dissolved in an aqueous solution typically degrades relatively quickly, which is a known factor that limits the application of these wetting agents.

Other features, benefits and advantages of the embodiments described herein not expressly mentioned above can be understood from this description and the drawings by those skilled in the art.

Of course, the above described embodiments are intended to be illustrative only and in no way limiting. The described embodiments are susceptible to many modifications of form, arrangement of parts, details and order of operation. The invention, rather, is intended to encompass all such modification within its scope, as defined by the claims.

1. A method of forming a porous polymeric material, comprising:
polymerizing a bicontinuous microemulsion comprising water, a wetting agent, a monomer, and a surfactant copolymerizable with said monomer, to form a polymer defining interconnected pores,
wherein said wetting agent comprises a cross-linkable wetting agent such that after said polymerizing, at least a portion of said cross-linkable wetting agent is cross-linked with said polymer.

2. The method of claim 1, wherein said cross-linkable wetting agent is an acrylated hyaluronic acid.

3. The method of claim 1, wherein said cross-linkable wetting agent is a methacrylated hyaluronic acid.

4. The method of claim 1, wherein after said polymerizing, an unbonded portion of said wetting agent is dispersed in said polymer and said pores, said unbonded portion of said wetting agent being releasable from said material.

5. The method of claim 1, wherein said wetting agent comprises a hyaluronic acid.

6. The method of claim 1, wherein said wetting agent comprises polyvinylpyrrolidone or dextran.

7. The method of claim 1, wherein said monomer is methyl methacrylate or 2-hydroxyethyl methacrylate.

8. The method of claim 1, wherein said surfactant is a zwitterionic surfactant.

9. The method of claim 8, wherein said zwitterionic surfactant is 3-((11-acryloyloxyundecyl)-imidazolyl) propyl sulfonate.

10. The method of claim 1, wherein said microemulsion comprises from about 0.1 to about 0.5 wt % of said wetting agent.

11. The method of claim 10, wherein said microemulsion comprises from about 0.25 to about 0.35 wt % of said wetting agent.

12. The method of claim 1, wherein said microemulsion comprises from about 15 to about 50 wt % of said water, from about 5 to about 40 wt % of said monomer, and from about 10 to about 50 wt % of said surfactant.

13. A porous polymeric material formed according to the method of claim 1.

14. A contact lens comprising the porous polymeric material of claim 13.

15. A porous material comprising:
a transparent polymer matrix defining interconnected pores; and
a wetting agent, at least a portion of said wetting agent cross-linked with said polymer matrix.

16. The material of claim 15, wherein said wetting agent comprises methacrylated hyaluronic acid (MeHA), at least a portion of said MeHA being cross-linked with said polymer matrix.

17. The material of claim 15, wherein said wetting agent comprises an acrylated hyaluronic acid (AHA), at least a portion of said AHA being cross-linked with said polymer matrix.

18. The material of claim 15, wherein said wetting agent comprises an unbonded portion dispersed in one or both of said polymer matrix and said pores, said unbonded portion of said wetting agent being releasable from said material.

19. The material of claim 15, wherein said wetting agent comprises a hyaluronic acid.

20. The material of claim 15, wherein said wetting agent comprises polyvinylpyrrolidone or dextran.

21. The material of claim 15, wherein said polymer matrix comprises polymerized methyl methacrylate or 2-hydroxyethyl methacrylate.

22. The material of claim 15, comprising from about 0.1 to about 0.5 wt % of said wetting agent.

23. The material of claim 15, comprising from about 0.25 to about 0.35 wt % of said wetting agent.

24. The material of claim 15, wherein said pores have a pore diameter of about 60 to about 120 nm.

25. A contact lens comprising the material of claim 15.
